(19) United States
(12) Patent Application Publication
(10) Pub. No.: US 2016/0334823 A1
(43) Pub. Date: Nov. 17, 2016

(54) COMPUTER CONTROLLED OCCUPANCY SENSORS SYSTEM

(71) Applicant: Srikanth RANGINENI, NELLORE (IN)

(72) Inventor: Srikanth RANGINENI, NELLORE (IN)

(21) Appl. No.: 15/113,828

(22) PCT Filed: Jan. 26, 2015
(86) PCT No.: PCT/IB2015/050559

§ 371 Date: Jul. 24, 2016

(30) Foreign Application Priority Data
Jan. 28, 2014 (IN) 355/CHE/2014

(51) Int. Cl. G05F 1/66; G05B 15/02

(52) U.S. Cl. CPC G05F 1/66; G05B 15/02

(57) ABSTRACT

Disclosed is automatically controlled occupancy sensors system. In one implementation, a system and method for dynamically adjusting one or more properties of one or more sensor based on one or more event captured on one or more electrical or electronic device and a current state of said electrical or electronic device corresponding to a location of the one or more sensors, to thereby control the working of other systems is disclosed. The system comprises of the electrical or electronic device configured to capture one or more event on said electrical or electronic device, thereby detect current state of said device; and transmit one or more message to said sensor related to said event captured and said current state detected. The system also comprises of the sensor configured to control working of one or more other systems based on said properties adjusted in response to the message received.

### TECHNICAL FIELD

The present subject matter described herein, in general, relates to a system and method of controlling working of electrical or electronic devices based on sensing techniques, and more particularly to an automatically controlled occupancy sensors system.

### BACKGROUND

In workplaces, there will be numerous instances when a user has to stay away from his seat to attend other activities. When user is no longer sitting in his workplace, the electrical loads viz. lights, air conditioners, fans etc. corresponding to the user's seat can be turned off to save power. Currently, this is automatically accomplished using occupancy/motion sensors.

However, the working of occupancy sensors may be dependent on the external factors that may include but not limited to movements of any object that may trigger a stimulus for the working, etc. Usually, the occupancy sensors wait for external movement/stimuli for a specified amount of idle time before actually turning off the load circuits connected to it. In some instances there is no need to wait for the entire specified amount of idle time to turn off the load circuits connected to it. For example, if a user moves out from his workplace or room then the light can be turned off immediately.

Thus, there is a need to provide an efficient system and method which is capable of reducing the above mentioned delay substantially and still achieve the intended task of controlling the electrical loads.

### SUMMARY OF THE INVENTION

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

### Existing Technical Problem

The existing occupancy sensors usually waits for external movement/stimuli for a specified amount of idle time even when user(s) has moved out of the location being monitored by the sensor before actually turning off (or send specified signals to) the light(s) or any other load/control circuits connected to it. Thus there is a delay in achieving the task and hence there is a power loss due this delay.

### Technical Solution Provided in the Present Invention

The present invention provides a design that dynamically controls the idle time of occupancy sensors based on the detected user presence through activity/inactivity/state on the user computer(s corresponding to the location of the occupancy sensor), monitoring or detecting user movements or presence through Swipe In/Swipe Out of access cards or through any other electronic means of user authentication/identification. This helps to reduce the delay in the process by promptly responding to the user movements/presence to save the power.

Accordingly, in one implementation, a method for dynamically adjusting one or more properties or features of one or more sensor based on one or more event captured on one or more electrical or electronic device and a current state of said electrical or electronic device corresponding to a location of the one or more sensors, to thereby control the working of one or more other system is disclosed. The method comprises of
(1) capturing, using/from said electrical or electronic device, one or more event on said electrical or electronic device, thereby detecting said current state of said electrical or electronic device;
(2) transmitting, using said electrical or electronic device, one or more message to said sensor, wherein said message is associated with said event captured and/or said current state detected, thereby
(3) dynamically adjusting said properties or features of said sensor based on said message received by said sensor, wherein said properties are used to control working of one or more other system.

In one implementation, a system for dynamically adjusting one or more properties of one or more sensor based on one or more event captured on one or more electrical or electronic device and a current state of said electrical or electronic device corresponding to a location of the one or more sensors, to thereby control the working of one or more other system. The system comprises of the electrical or electronic device configured to capture one or more event on said electrical or electronic device, thereby detect said current state of said electrical or electronic device; and transmit one or more message to said sensor related to said event captured and/or said current state detected. The sensor configured to control working of one or more other system based on said properties adjusted in response to the message received.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE ACCOMPANYING DRAWINGS

The above and other aspects, features, and advantages of certain exemplary embodiments of the present invention will be more apparent from the following description taken in conjunction with the accompanying drawings in which:

FIG. 1 illustrates a computer controlled occupancy sensors system when an active event or user activity detected from the computer(s) (1), as shown, in accordance with an embodiment of the present subject matter.

FIG. 2 illustrates a computer controlled occupancy sensors system when an inactive event or user inactivity detected from the computer(s) (1), as shown, in accordance with an embodiment of the present subject matter.

FIG. 3 illustrates a computer(s) (1) communicates directly with occupancy sensor (4) and to a load/circuit through, as shown, in accordance with an embodiment of the present subject matter.

FIG. 4 illustrates computer(s) (1) communicates directly with occupancy sensor (4) or through the gateway (3), as shown, in accordance with an embodiment of the present subject matter.

FIG. 5 illustrates computer(s) (1) communicates directly with occupancy sensor (4) or through the gateway (3) or through the server (2), as shown, in accordance with an embodiment of the present subject matter.

FIG. 6 illustrates each server (2), gateway (3), occupancy sensor (4) can simultaneously interact with multiple computers (1), multiple gateways (3) or multiple servers (2) or multiple occupancy sensors (4) over communication channels, as shown, in accordance with an embodiment of the present subject matter.

FIG. 7 illustrates the occupancy sensor can be a standalone device or a simple sensor that is connected (wired or wireless connection) to a controller unit to which multiple other occupancy sensors are connected, as shown, in accordance with an embodiment of the present subject matter.

FIG. 8 illustrates a block diagram of the over-all invention, as shown, in accordance with an embodiment of the present subject matter.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION OF THE PRESENT INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

While aspects of described computer controlled occupancy sensors system may be implemented in any number of different computing systems, environments, and/or configurations, the embodiments are described in the context of the following exemplary system.

When a user is not located in his workplace then the idle time of the occupancy sensor controlling the light(s) or other load circuit(s) in that area can be decreased thereby lowering the power consumption by turning off the lights or other load circuits in a lesser amount of time than when the idle time is higher. If the user is seated in his workplace, the idle time of the occupancy sensor controlling the lights or other load circuits in that area can be increased so that, the user doesn't experience inconvenience from frequent switching of the lights or other load circuits when he is sitting motion less in his seat. In this way more power can be saved by dynamically controlling the idle time of the occupancy sensors.

Occasionally, when people have to move away from their workplaces, they will lock their computer or turn it off or put it in sleep or hibernate mode or swipe out their access card while moving out of the room. Whenever a computer is turned off or put in sleep or hibernate mode or when user locks the computer or when a user moves out of a workplace after swiping out his access card, a message (may be in signal form) is sent to the server or occupancy sensor either through wired/wireless mechanism directly/indirectly to reduce the idle time of the occupancy sensor that controls the light(s) or other load/control circuits corresponding to the user's computer terminal(s) or seat or occupancy sensor. Similarly, whenever, a user logs in or unlocks his computer or uses any devices connected to the computer (key press, mouse movement etc.) or moves into a workplace after swiping in his access card, then a message is sent to the server or occupancy sensor either through wired/wireless mechanism directly/indirectly to increase the idle time of the occupancy sensor that controls light(s) or other load/control circuits corresponding to the user's computer terminal(s) or seat or occupancy sensor.

### Explanation of Definitions Used in Description

It is to be understood that the below mentioned definitions are provided just to make the reader of this invention understand the terminologies used, the person skilled in the art may understand technical definitions of the below mentioned terminologies if not accurately provided:

In the present specification, occurrence of one or more of the following events is regarded as active event. Some of the example of the active events may include but not limited to:
1. User unlocks his computer (unlocks his account in computer)
2. User “Log In” into the Computer
3. User computer (or electronic or electrical device) wakes up from sleep or hibernate state or any other low power state defined by Advanced Configuration and Power Interface (ACPI) specification or any other semi/inactive/low power states
4. User computer is turned ON
5. Pressing one or more keys, mouse movements, or use of any device connected to the computer or monitoring the usage of computer/any device connected to the computer in order to send message to the server or controller or sensor to increase the idle time or send the message that user is in his workplace and process it further as desired.
6. User swipes in his access card while entering a room
7. User authenticated/identified/detected while entering a room through any electronic/electrical means
8. Presence of user in a particular room or area is authenticated/identified/detected through any electronic/electrical means
9. Events or Interrupts from any automatic scheduled activity indicating the start of working hours or any other time/date where there can be active user activity.

Further, the occurrence of one or more of the following events is regarded as an inactive event:
1. User session is locked (locks his account in computer)
2. User “Log off” the computer
3. User computer (or electronic or electrical device) enters into sleep or hibernate or any other low power state defined by ACPI specification state or any other semi/inactive/low power states
4. User computer is “Shutdown”/turned off
5. Pressing one or more keys, mouse movements, or use of any device connected to the computer or monitoring the usage of computer/any device connected to the computer in order to send message to the server or controller or sensor to decrease the idle time or send the message that user is about to leave his workplace and process it further as desired.
6. User swipes out his access card while moving out of a room
7. User authenticated/identified/detected while moving out of a room through any electronic/electrical means
8. Absence of user in a particular room or area is authenticated/identified/detected through any electronic/electrical means
9. Events or Interrupts from any automatic scheduled activity indicating the end of working hours or start of holidays or any other time/date where there can be lesser or no user activity.

When active event occur the computer or any other electronic system for user detection is said to be in the active state. Similarly, when inactive event occur the computer or any other electronic system for user detection is said to be in the inactive state.

Occupancy sensor is any device that detects the presence of a person or specific objects by any means and controls the load/control circuits. It can use any technology viz. infrared, ultrasound, vibration sensing or detection by means of image/video processing etc. or any combination of one or more technologies.

Idle time is the time period for which occupancy sensor doesn't detect/waits for any user/motion/specified object before turning off the light(s) or any load/control circuit or initiating stipulated action. Idle time is also widely referred as ‘timeout’ or ‘occupancy sensor's timeout’ in the existing art.

Decreasing the idle time of occupancy sensor may mean setting a predetermined lower value for the idle time of the occupancy sensor.

Increasing the idle time of occupancy sensor may mean setting a predetermined higher value for the idle time of the occupancy sensor. Detected user activity is triggered when:
a) A person uses any devices(s) (keyboard, mouse, monitor, modems, external drives, joy stick, printer etc.) connected to the computer or by but not limited to only these;
b) Monitoring the changes in specified usage (needn't always be from a user) of any device(s) connected to the computer but not limited to only these.
c) User entry into a room/workplace or user presence in room/workplace is authenticated/identified/detected through any electronic/electrical means.

Detected User Inactivity is triggered when:
a) A person doesn't use any device(s) (keyboard, mouse, monitor, modems, external drives, joy stick, printer etc.) connected to the computer for a predetermined amount of time, but not limited to only these;
b) Monitoring the changes in specified usage (needn't always be from a user) of any device(s) connected to the computer but not limited to only these.
c) User moves out of a room/workplace or user absence in room/workplace is authenticated/identified/detected through any electronic/electrical means.

Computer can be an electronic device which is capable of receiving information in a particular form and of performing a sequence of operations in accordance with a predetermined but variable set of procedural instructions to produce a result in the form of information or signals.

Electrical or electronic devices on which active/inactive events/states are generated or monitored may comprise computers, tablets, ASICs, televisions, telephones, electronic gadgets, timers, audio systems, RFID systems, biometric identification systems, augmented reality devices similar to Google Glass®, wearable computers, virtual reality devices or any other sensing systems, automation systems, any electrical/electronic devices, etc. and any combination thereof.

Wherever turning on/off of lights or load or control circuits is mentioned, it may be understood that it can also represent controlling the lights or load or control in any other fashion (adjusting the brightness, cooling and the like) allowed by those systems.

If an active event occurs or active state is detected, the idle time of the sensor can be increased. Similarly, if an inactive event occurs or inactive state is detected, the idle time of the sensor can be decreased. The other properties or features of the sensor can also be correspondingly adjusted based on active/inactive events/states.

In one implementation, the present invention provides a design that dynamically controls the idle time or the other properties of occupancy sensor based on identifying/authenticating/sensing through any electronic or any other means the user presence or absence in a room/workplace or user movements into/out of a room/workplace and controlling the idle time of the occupancy sensor corresponding to the location of the user's seat (in the room/workplace) or the occupancy sensor. If a user presence is identified/authenticated the idle time of the occupancy sensor is increased and vice versa.

In one implementation, the present invention provides a design that dynamically controls the idle time or the other properties of occupancy sensor based on the detected activity/inactivity/state on the user computer(s) corresponding to the location of the user's seat (in the room/workplace) or the occupancy sensor.

Accordingly, in one implementation, a method for dynamically adjusting one or more properties or features of one or more sensor based on one or more event captured on one or more electrical or electronic device and a current state of said electrical or electronic device corresponding to a location of the one or more sensors, to thereby control the working of one or more other system is disclosed. The method comprises of:
(1) capturing, using/from said electrical or electronic device, one or more event on said electrical or electronic device, thereby detecting said current state of said electrical or electronic device;
(2) transmitting, using said electrical or electronic device, one or more message to said sensor, wherein said message is associated with related to said event captured and/or said current state detected, thereby
(3) dynamically adjusting said properties or features of said sensor based on said message received by said sensor, wherein said properties or features are used to control working of one or more other system.

In one implementation, a system for dynamically adjusting one or more properties of one or more sensor based on one or more event captured on one or more electrical or electronic device and a current state of said electrical or electronic device corresponding to a location of the one or more sensors, to thereby control the working of one or more other system is disclosed. The system comprises of the electrical or electronic device configured to capture one or more event on said electrical or electronic device, thereby detect said current state of said electrical or electronic device; and transmit one or more message to said sensor related to said event captured and said current state detected. The sensor configured to control working of one or more other system based on said properties adjusted in response to the message received.

In one implementation, said properties or features of said sensor are associated with at least one of an idle time or turning said sensor on or off, or changing or modifying auto/manual on/off property, or changing range of said sensors, or changing the monitoring time of the data received from a sensor, or changing a sensitivity of said sensors, or changing or modifying adaptive self calibrating properties, or changing or modifying detection technology, or changing or modifying light level detection settings, or changing or modifying diming or dimmer properties, or changing or modifying clock frequency, sampling or signaling rate or any combination thereof.

In one implementation, said event captured on said electrical or electronic device is selected from a group comprising pressing one or more keys, mouse movements, biometric identification, RFID identification, swiping of an access card, user/object identification/authentication in a room/workplace, or identification through any other sensors or mechanisms, or use of electrical or electronic device or a use of any device connected to electrical or electronic device, events and interrupts associated with the electronic or electrical device, or any combination thereof.

In one implementation, the present invention may dynamically adjust said properties or features of said sensor based on time of said event captured and/or said state detected, wherein said time is selected from a group comprising a pre-defined time of a day or at least one day pre-defined from a set of days or a specific date pre-defined or any combination thereof.

In one implementation, said other system is associated with said sensor and is selected from a group comprising lighting systems, Heating, Ventilation and Air-Conditioning (HVAC) systems, computers, printers, faxes, scanners, televisions, audio systems, telephones, automation systems, any electrical or electronic system present at said location and any combination thereof.

In one implementation, wherein said properties or features of said sensor are pre-stored in one or more control circuit and said control circuit is configured to dynamically adjust said properties or features based on at least one of said event captured or said state detected or any combination thereof.

In one implementation, the present invention may dynamically adjust said properties in said circuit controller using one or more server, wherein said server is configured to monitor said electrical or electronic device at a pre-defined interval time to capture at least one of the said event or the state or the time and/or a specific date predefined or any combination thereof.

In one implementation, said event captured is selected from at least one of active event or an inactive event, and said state is selected form at least one of active state or an inactive state.

In one implementation, when the active event occurs the one or more electronic or electrical device is said to be in the active state, and when the inactive event occurs the one or more electronic or electrical device is said to be in the inactive state.

In one implementation, the at least one of active or inactive event detected and the one or more electronic or electrical device's transition between the at least one of an active or inactive states is caused by the user or through an automatic scheduled activity of the one or more electronic or electrical device.

In one implementation, said sensors are selected form a group comprising of occupancy sensors, vacancy sensors, motion sensors, light sensors, temperature sensors, humidity sensors, day light sensors, ambient light sensors, radiation sensors, vibration sensors, sound sensors, proximity sensors, pressures sensors, direction sensors, speed sensors, and any combination thereof.

In one implementation, said properties are overridable and may be altered automatically or manually either directly or by remotely accessing and configuring the system in order to satisfy the requirement of a user or the environment or of a system.

In one implementation, the present invention may store said event captured or said state detected or said time or any combination thereof in said server and is further configured to dynamically adjust said properties in said control circuit based on at least one of stored said event captured or said state detected or said time or any combination thereof.

In one implementation, present invention may include one or more control circuit storing said properties of said sensor and is configured to dynamically adjust said properties based on at least one of said event captured or event not captured within specified duration or said state detected or said time or any combination thereof.

In one implementation, present invention may include one or more servers configured to dynamically adjust said properties in said circuit controller, and monitor said electrical or electronic device at a pre-defined time interval to capture at least one of the said event or the state or the time or any combination thereof.

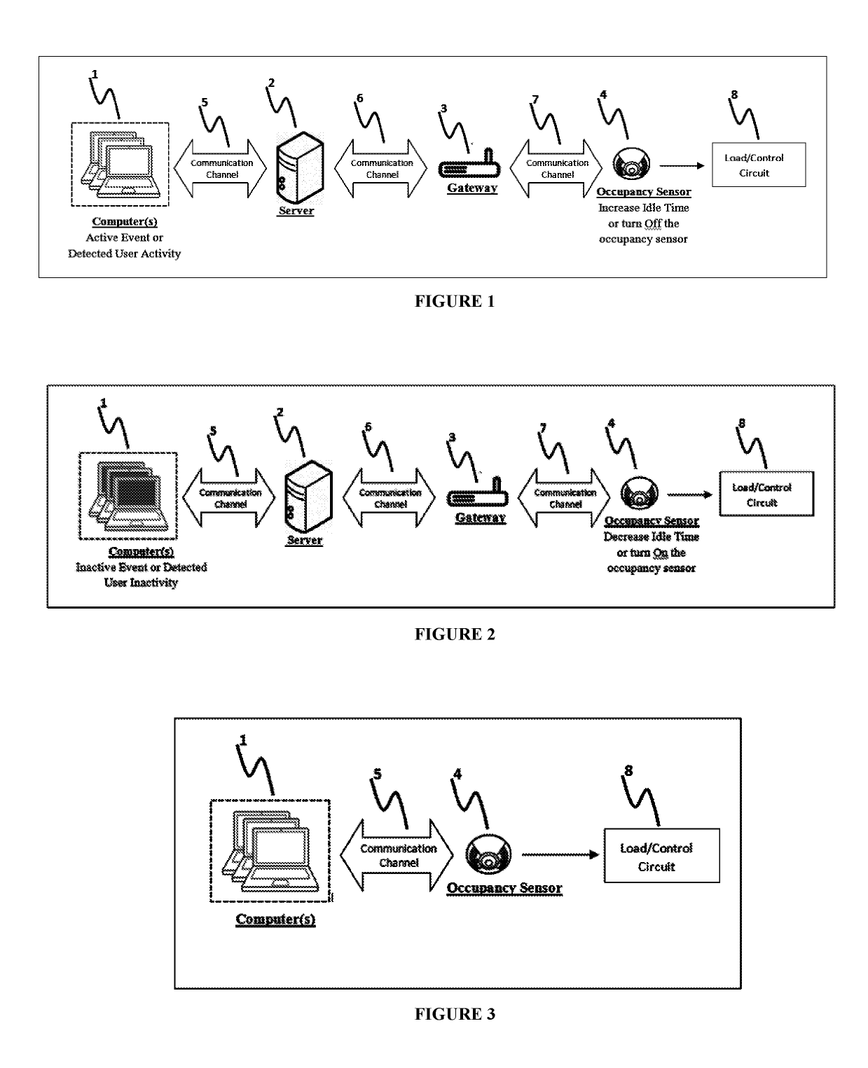

As shown in FIGS. 1-8, enumerated items are explained below, however it is to be understood that the below mentioned details are just as an exemplary embodiment of the present invention, and the actual system may have some complex or simpler technology and components involved for its working.
(1) is one or a group of computers (or any electrical or electronic device) that share (or represent) one or more lights or any other load/control circuit(s) mentioned in (8).
(2) is a server configured to receive messages from one or a group of multiple computers (1) and which in turn communicates with the protocol gateway(3) or occupancy sensor(4) (corresponding to the user computer/seat/room) to configure the idle time of occupancy sensor(4). It may be noted that any electronics circuit can be configured to work as a server ranging from a simple ASIC or microcontroller module, mini PC, workstation or complex cloud server etc.
(3) is a any protocol gateway or bridge that helps to connect the Server (2) (or user(s) computer(s)) and Occupancy Sensor (4). For e.g. if Communication channel (6) runs on Ethernet network and the occupancy sensor (4) runs on Zigbee protocol, then Gateway (3) acts as a bridge between LAN and Zigbee Network.
(4) is occupancy sensor that controls a light/group of lights/any load/control circuit corresponding to the user computer/group of user computers mentioned in (1).
(8) is one or more lights or one or more load circuits or one or more control circuits corresponding to the location of the group of user's computer(s) mentioned in (1).
(9) is controller(s) circuit(s) which can directly control the light(s)/load/control circuit(s) corresponding to the location of Computer(s) mentioned in (1) without the need of occupancy sensor mentioned in (4).
(5), (6), (7) these are wired or wireless communication channels/networks that can use various protocols viz. Ethernet, Wifi, Infrared, RF, Microwave signaling etc. or any other means of communication.

Referring now to FIG. 1, illustrates one form of the present invention, wherein active event or detected user activity from the computer(s) (1) is communicated to the server (2) which again transmits the message to occupancy sensor (4) through protocol gateway (3) to increase the idle time of the occupancy sensor (4) or to turn Off the occupancy sensor (4) corresponding to the user(s) computer(s) mentioned in (1).

Referring now to FIG. 2, illustrates inactive event or detected user inactivity from the computer(s) (1) is communicated to the server (2) which again transmits the message to occupancy sensor (4) through protocol gateway (3) to decrease the idle time of occupancy sensor (4) or to turn On the occupancy sensor (4) corresponding to the user(s) computer(s) mentioned in (1).

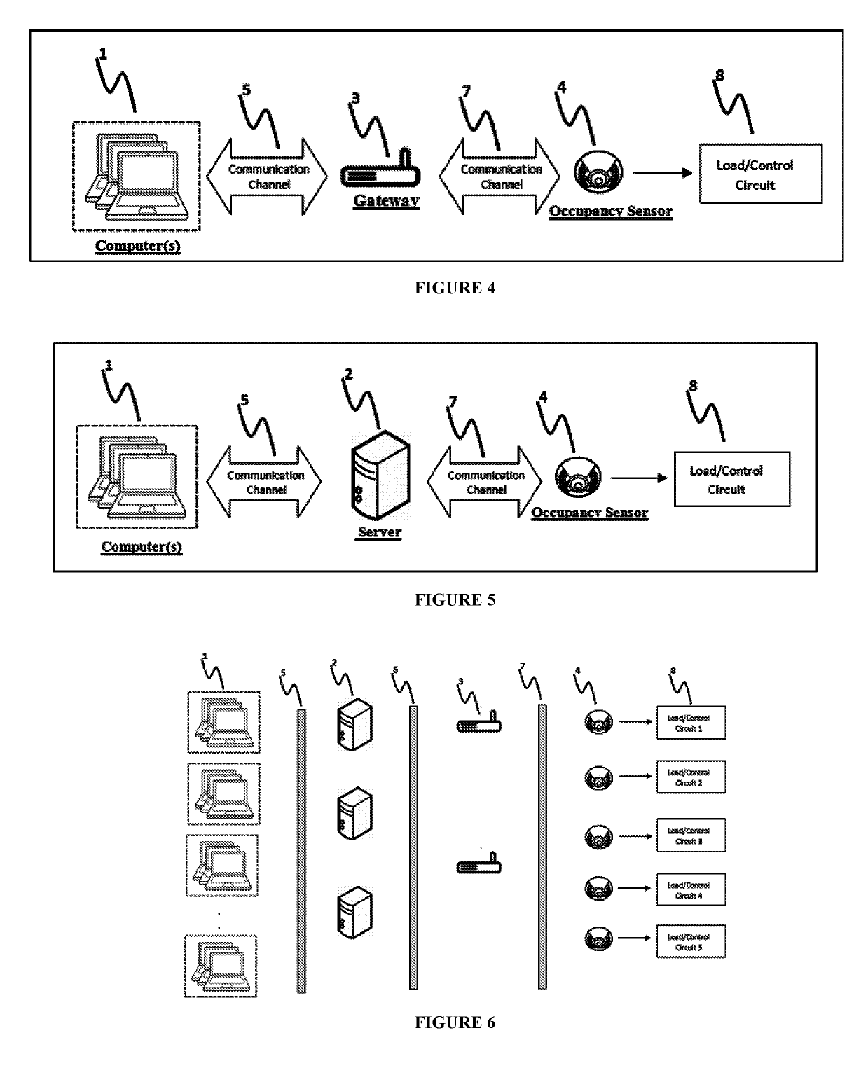

It may be understood by the person skilled in the art that the system may be implemented in multiple ways to control the idle time of the occupancy sensor (4) based on active/inactive events and/or detected user activity/inactivity on the user(s) computer(s). For e.g. in other embodiments of the invention as depicted in FIG. 3, FIG. 4 and FIG. 5, user computer(s) (1) communicates directly with occupancy sensor (4) or through the gateway (3) or through the server (2) in between them respectively.

In one implementation, when occupancy sensor is turned Off (i.e. setting infinite idle time to the occupancy sensor), the load/control circuit it controls has access to the power supply. When occupancy sensor is turned On, it can curtail power to the load/control circuit if there is no motion detected in its range within the specified idle time.

In one implementation, there may not be any need to set the idle time of the occupancy sensor (4) every time on triggering of detected user activity. A predetermined buffer time can be set before checking/setting the status of the occupancy sensor (4) on detecting the user activity.

In one implementation, apart from receiving information from different sources, the server (2) will also periodically monitor the user(s) computer(s) (1) to check whether it/they are in active/inactive state or monitor the detected user activity/inactivity on the user computers (1) over the communication channels (5). In case if user computer(s) (1) is inactive or has no user activity for a specified time, the idle time of the occupancy sensor (4) is reduced or the occupancy sensor (4) is turned On. In case if user computer(s) (1) is in active state or detected user activity, the idle time of the occupancy sensor (4) is increased or the occupancy sensor (4) is turned Off.

In one implementation, in cases where multiple users are sharing one or more lights, the server (2) will monitor the state of all the computers mentioned in (1) that share one or more lights (8) before deciding to increase/decrease the idle time of the occupancy sensor(s) (4) or to turn On/Off the occupancy sensor(s) (4) shared by a group of users. This is because, if multiple users are sharing occupancy sensor(s) (4) and if one of the user moves away from his workplace, then state of the computers of the other users in that group need to be checked before decreasing the idle time of the occupancy sensor(4) or turning On the occupancy sensor(4). If any of the other computers in the group is still in active state, the idle time of the occupancy sensor should be at a predetermined higher value or the occupancy sensor (4) should remain Off.

In above points it is explained how to dynamically increase/decrease the idle time of occupancy sensor (4) by monitoring active/inactive events, it may be understood by the person skilled in the art, that the same functionality can be implemented indirectly in many ways including:
a. Triggering new events after the occurrence of active/inactive events and monitoring the new events/states instead of active/inactive events mentioned above and deciding to increase/decrease the idle time of the occupancy sensor(s). For e.g. if computer is configured to turn off the display (immediately or after some buffer time which is different than the display turnoff schedule when computer is in unlocked state) when computer is locked, then display turn off can be taken as trigger input to decrease the idle time of the occupancy sensor(s) at the location of the user computer. In this way there may be a nested linking of multiple events to active/inactive events discussed in this specification which can be monitored to increase/decrease the idle time of the occupancy sensor(s).
b. Instead of immediately acting after the happening of active/inactive events the happenings of active/inactive states will be recorded first. The recorded data or computer state is periodically monitored and idle time of occupancy sensor(s) is controlled accordingly. For e.g. if the computer is locked (which is regarded as occurrence of inactive event) then instead of immediately sending the message to decrease the idle time of the occupancy sensor(s), the happening of lock event is recorded. This will be noticed during periodic monitoring of the recorded data or state of the computer and appropriate action is initiated to decrease the idle time of the occupancy sensor(s).

In one implementation, occasionally, user may not voluntarily execute inactive events while moving away from the computer terminal. Usually, there will be power management and/or display control programs installed on the computer that automatically invoke inactive events and take the computer to inactive state as per the scheduled plan. Also, some workplaces employ a mechanism that takes all the computers into inactive state at the scheduled predefined time (e.g. automatically turning off all systems after work hours). So, the proposed invention can also control the occupancy sensors(4) based on the active/inactive events and computer's transition between active and inactive states irrespective of whether the active/inactive events and state change is caused by the user or through any automatic scheduled activity.

In one implementation, occasionally, user might remotely connect to the computer other than from the location of the user's computer terminal in workplace. So, while sending the message to increase/decrease idle time of the occupancy sensor apart from checking for the active/inactive events/states, detected user activity/inactivity etc. the location of the user can also be determined (by detecting the source of user signals etc.) and idle time of the occupancy sensor (4) can be adjusted accordingly.

In one implementation, it may be understood that in some cases a single user computer comprises a single CPU with multiple terminals to simultaneously support multiple users. In this case, the location of the individual terminal can also be sent along with message to increase/decrease the idle time of the occupancy sensor (4) or server (2) or gateway (3).

In one implementation, it may be understood that though server (2) and gateway (3) are shown separately in different embodiments mentioned in this invention, it is possible for them to exist together as one unit (along with other circuits as well).

It may be understood that that each server (2), gateway (3), occupancy sensor (4) can simultaneously interact with multiple user computers (1), multiple gateways (3) or multiple servers (2) or multiple occupancy sensors (4) over communication channels as depicted in FIG. 6. The patterns of interaction can be configured as required.

It may be understood that, some occupancy sensors come with adjustable range (area monitored by an occupancy sensor). In such case the range of the sensor may also be configured or changed along with the idle time as per the requirement.

It may be understood that depending on the requirement, the system can be configured to properties or features of said sensor are associated with at least one of an idle time or turning said sensor on or off, or changing range of said sensors, or changing a sensitivity of said sensors, or changing or modifying auto on/off property, or changing or modifying light level detection settings, changing or modifying diming or dimmer properties, or any combination thereof or separately in different occupancy sensors spread across a given area/room and the like.

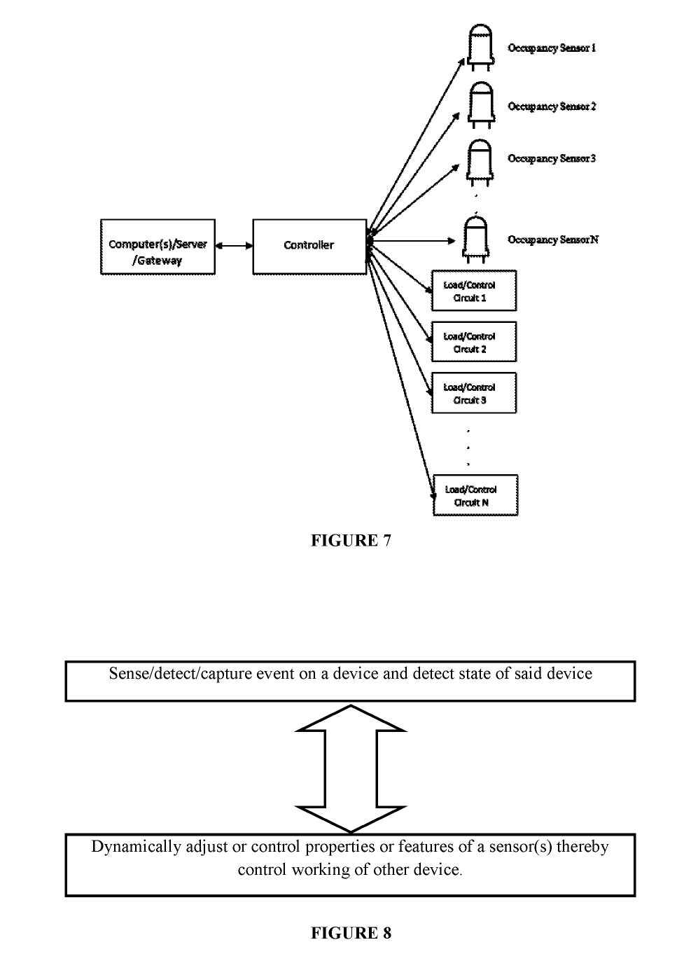

Referring now to FIG. 7, the occupancy sensor can be a standalone device or it can be a simple sensor that is connected (wired or wireless connection) to a controller unit to which multiple other occupancy sensors are connected. The controller unit also controls the load/control circuits corresponding to the location of the occupancy sensors. The controller unit can be configured to communicate with either user computer(s) (1) or server (2) or protocol gateway (3). In FIG. 8, occupancy sensors 1 to N, are simple sensors that are connected to controller unit. In this case, the controller unit may also implement and monitor the idle time functionality of the occupancy sensors and controls the corresponding load/control circuits accordingly. The controller, sensor and load circuits needn't be in proximity and can also coexist with other circuits. For e.g. the controller can be mounted along with the electric switch board of the load circuits it controls while sensors and load circuits can be elsewhere. In another embodiment of this invention, the occupancy sensors can be mounted/inbuilt/connected on the telephone corresponding to the location of the user computer (1). In which case the occupancy details are communicated to the controller unit on the same network the telephone is using or on any other protocol supported by the phone.

It may be understood by the person skilled in the art that in this way, the load/control circuits corresponding to the user(s) location may be controlled by means of active/inactive events or by monitoring the active/inactive state or detected user activity/inactivity on the computer(s) through multiple means.

In one implementation, it will be understood by the person skilled in the art that the invention mentioned above can control any equipment other than the lights. For example, the occupancy sensors can also be used to control the HVAC in the rooms. Whenever a system is locked and idle time of the sensor is decreased, HVAC cooling can be decreased within a shorter span of time (if occupancy is not detected) thereby saving the power.

In one implementation, the idle time or the properties of the sensor is updated/set based on time of a day. For example, the idle time of the sensor may be decreased during non-working hours and vice versa. Similarly, idle time of the sensor can be decreased during the holidays. Other properties of the sensor viz. range, sensitivity etc. can also be simultaneously modified based on the time of the day and date as required.

In one implementation, the magnitude of increase/decrease in the idle time or the other properties of the sensor can be configured based on the events/states detected. For example, the idle time of the sensor may be decreased by a greater magnitude when a user moves out of room after swiping out his access card than when the user is still in his workplace and locks his computer though both are inactive events.

Apart from using computer usage to control the properties of sensor, other methods of detecting user presence by any electrical or electronic system viz. swipe In/Out of access cards, biometric identification of the user during entry/exit of the rooms or any other method to detect presence or absence of the user can also be used to control the properties of sensor. If user presence/entry is detected, idle time of sensor can be increased and vice-versa.

Referring now to FIG. 8 illustrates a block diagram of the over-all invention, as shown, in accordance with an embodiment of the present subject matter. In one implementation, as shown in FIG. 8, a means may be provided to sense/detect/capture event on a device and detect state of said device. Further, said event and/or state may be transmitted to a second means in the form of a message. The second means may be configured to dynamically adjust or control properties or features of a sensor(s) thereby control working of other device.

In one example, the first means may be configured to sense/detect/capture the swipe in/swipe out, biometric identification, detecting user presence, and the like events performed by the user in workplace. Further, in one aspect the first means may sense the presence of user mobile, tablet, access card in the workplace. Based on the sense/detect/capture a message may be transmitted to the second means which dynamically adjust/changes the properties/features of the sensor associated with the said first means thereby controlling the working of other nearby devices in the workplace.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description.

1. A method for dynamically adjusting one or more properties or features of one or more sensor based on one or more event captured on one or more electronic device and/or a current state of said electronic device corresponding to a location of the one or more sensors, to thereby control the working of one or more other system, said method characterized by comprising:
capturing, using/from said electronic device, one or more event on said electronic device, thereby detecting said current state of said electronic device;
transmitting, using said electronic device, one or more message to said sensor, wherein said message is associated with said event captured and/or said current state detected, thereby
dynamically adjusting said properties or features of said sensor based on said message received by said sensor, wherein said properties are used to control working of one or more other system.

2. The method of claim 1, wherein said properties or features of said sensor are associated with at least one of an idle time or turning said sensor on or off, or changing or modifying auto/manual on/off property, or changing range of said sensors, or changing the monitoring time of the data received from a sensor, or changing a sensitivity of said sensors, or changing or modifying adaptive self calibrating properties, or changing or modifying detection technology, or changing or modifying light level detection settings, or changing or modifying dimming or dimmer properties, or changing or modifying clock frequency, sampling or signaling rate or any combination thereof.

3. The method of claim 1, wherein said event captured on said electronic device is selected from a group comprising pressing one or more keys, mouse movements, biometric identification, RFID identification, swiping of an access card, user/object identification/authentication in a room/workplace, or identification through any other sensors or mechanisms, or use of electronic device or a use of any device connected to electronic device, events and interrupts associated with the electronic, or any combination thereof.

4. The method of claim 1, wherein said other system is associated with said sensor and is selected from a group comprising lighting systems, Heating, Ventilation and Air-Conditioning (HVAC) systems, computers, printers, faxes, scanners, televisions, audio systems, telephones, automation systems, any electronic system present at said location and any combination thereof.

5. The method of claim 1, wherein said properties or features of said sensor are pre-stored in one or more control circuit and said control circuit is configured to dynamically adjust said properties or features based on at least one of said event captured or said state detected or any combination thereof.

6. The method of claim 1 comprises dynamically adjusting said properties in said circuit controller using one or more server, wherein said server is configured to monitor said electronic device at a pre-defined interval time to capture at least one of the said event or the state or the time and/or a specific date predefined or any combination thereof.

7. The method of claim 1, wherein said event captured is selected from at least one of active event or an inactive event, and said state is selected form at least one of active state or an inactive state.

8. The method of claim 1, wherein the at least one of active or inactive event detected and the one or more electronic device's transition between the at least one of an active or inactive states is caused by the user or through an automatic scheduled activity of the one or more electronic device.

9. The method of claim 1 comprises dynamically adjusting said properties or features of said sensor based on time of said event captured and/or said state detected, wherein said time is selected from a group comprising a pre-defined time of a day or at least one day pre-defined from a set of days or a specific date pre-defined or any combination thereof.

10. The method of claim 1, wherein said sensors are selected form a group comprising of occupancy sensors, vacancy sensors, motion sensors, light sensors, temperature sensors, humidity sensors, radiation sensors, vibration sensors, sound sensors, proximity sensors, pressures sensors, direction sensors, speed sensors, and any combination thereof.

11. The method of claim 1, wherein said properties or features, are overridable.

12. The method of claim 1 comprises storing of said event captured or said state detected or said time or said date or any combination thereof in said server and is further configured to dynamically adjust said properties in said control circuit based on at least one of stored said event captured or said state detected or said time or said date or any combination thereof.

13. A system for dynamically adjusting one or more properties of one or more sensor based on one or more event captured on one or more electronic device and a current state of said electronic device corresponding to a location of the one or more sensors, to thereby control the working of one or more other system, said system comprising:
said electronic device configured to
capture one or more event on said electronic device, thereby detect said current state of said electronic device; and
transmit one or more message to said sensor related to said event captured and said current state detected; and
said sensor configured to
control working of one or more other system based on said properties adjusted in response to the message received.

14. The system of claim 13 comprises one or more control circuit storing said properties of said sensor and is configured to dynamically adjust said properties based on at least one of said event captured or said state detected or on time of said event captured and/or said state detected or any combination thereof.

15. The system of claim 13 comprises one or more server configured to monitor said electronic device at a pre-defined interval time to capture said event or said state or the time or any combination thereof, and dynamically adjust said properties in said sensor and/or said circuit controller.

16. The system of claim 13, wherein said event captured on said electronic device is selected from a group comprising pressing one or more keys, mouse movements, biometric identification, RFID identification, swiping of an access card, user/object identification/authentication in a room/workplace, or identification through any other sensors or mechanisms, or use of electronic device or a use of any device connected to electronic device, events and interrupts associated with the electronic, or any combination thereof.

17. The system of claim 13, wherein said other system is associated with said sensor and is selected from a group comprising lighting systems, Heating, Ventilation and Air-Conditioning (HVAC) systems, computers, printers, faxes, scanners, televisions, audio systems, telephones, automation systems, any electronic system present at said location and any combination thereof.

18. The system of claim 13, wherein the at least one of active or inactive event detected and the one or more electronic device's transition between the at least one of an active or inactive states is caused by the user or through an automatic scheduled activity of the one or more electronic device.

19. The system of claim 13, wherein said sensors are selected form a group comprising of occupancy sensors, vacancy sensors, motion sensors, light sensors, temperature sensors, humidity sensors, radiation sensors, vibration sensors, sound sensors, proximity sensors, pressures sensors, direction sensors, speed sensors, and any combination thereof.

20. The system of claim 13 comprises storing of said event captured or said state detected or said time or said date or any combination thereof in said server and is further configured to dynamically adjust said properties in said control circuit based on at least one of stored said event captured or said state detected or said time or said date or any combination thereof.
